(19) United States
(12) Patent Application Publication
(10) Pub. No.: US 2008/0018457 A1
(43) Pub. Date: Jan. 24, 2008

(54) Information System in a Vehicle

(75) Inventors: Martin Keppler, Oberreichenbach (DE); Roland Pregizer, Tuebingen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, STUTTGART (DE)

(21) Appl. No.: 10/590,697

(22) PCT Filed: Feb. 22, 2005
(86) PCT No.: PCT/EP05/01809

§ 371 Date: May 9, 2007

(30) Foreign Application Priority Data
Feb. 28, 2004 (DE) 10-2004-009-769.8

(51) Int. Cl. G01C 21/00

(52) U.S. Cl. 340/539.13

(57) ABSTRACT

An information system in a vehicle includes a storage medium for storing data, a drive mechanism for driving the storage medium, a control device configured to control the drive mechanism of the storage medium at at least two different speeds, a first speed being higher than a second speed. The control device may be configured to store data on the storage medium by driving the drive mechanism to determine the standstill state of the vehicle using sensor data and to control the drive device at the first speed if the vehicle is at a standstill.

### CROSS REFERENCE TO RELATED APPLICATIONS

This application is a national stage of PCT International Application No. PCT/EP2005/001809, filed Feb. 22, 2005, which claims priority under 35 U.S.C. § 119 to German Patent Application No. 10 2004 009 796.8, filed Feb. 28, 2004, the entire disclosures of which are herein expressly incorporated by reference.

### BACKGROUND AND SUMMARY OF THE INVENTION

The present invention relates to an information system in a vehicle.

European patent document EP 0 699 895 B1 describes a vehicle navigation system including a CD player having a variable rotational speed. Data can be read from the CD at a variable speed, because the drive mechanism of the CD player is driven at a variable speed.

Japanese patent document JP 2003035543 A describes a vehicle navigation system including a storage medium, in which a digital map is issued to perform map-matching to determine whether the road currently being used is paved. If it is determined that the road currently being used has not been paved, access to the storage medium of the vehicle navigation system is blocked.

Japanese patent document JP 2003014467 A describes a vehicle navigation system including a storage medium, in which the storage medium is equipped with a vibration sensor. The speed of the read access to the storage medium is changed as a function of the detected vibrations.

One object of the present invention is to specify an improved information system which allows for efficient write access to the storage medium of the information system.

This and other objects and advantages are achieved by an information system according to the present.

Advantageous developments of the invention are specified in the dependent claims.

In an exemplary embodiment of the invention, rapid writing of data to the storage medium in the information system is made possible if a standstill state of the vehicle is determined. As a result, full flexibility is maintained when writing data in the standstill state and/or during the movement of the vehicle. Writing operations are carried out more rapidly and therefore more cost-effectively during the standstill state. At the same time, it is ensured that the storage medium is not damaged by vibrations during a writing operation.

The information system optionally comprises a navigation system. In one exemplary embodiment of the invention, the map data for the navigation system are stored on the storage medium and are read from the storage medium during operation of the navigation system.

The operating software of the information system and/or the navigation system can optionally be stored on the storage medium. The operating software may comprise, for example, data relating to the control panel of the information system. In a further advantageous embodiment of the invention, data from applications of the information system, for example, a text-to-speech application, are stored on the storage medium.

In another exemplary embodiment of the invention, the storage medium is in the form of a hard disk. Data can be written to the hard disk at at least two different speeds, the higher speed being provided for the writing operation when the vehicle is at a standstill. In this manner, large quantities of data can be written to the hard disk in a short period of time. For this purpose, the information system may optionally comprise a CD drive and/or a DVD drive. Data from a CD and/or DVD can then be transferred rapidly to the hard disk and stored on it. In this case, the standstill state of the vehicle may be checked in order to avoid damage to the hard disk due to vibrations during the writing operation.

The second writing speed provided allows for a writing operation to the storage medium at a lower speed. This writing operation at the lower writing speed can also be carried out if the vehicle is moving.

Other objects, advantages and novel features of the present invention will become apparent from the following detailed description of the invention when considered in conjunction with the accompanying drawings.

### BRIEF DESCRIPTION OF THE DRAWING FIGURE

FIG. 1 illustrates an exemplary embodiment of an information system in a vehicle according to the present invention.

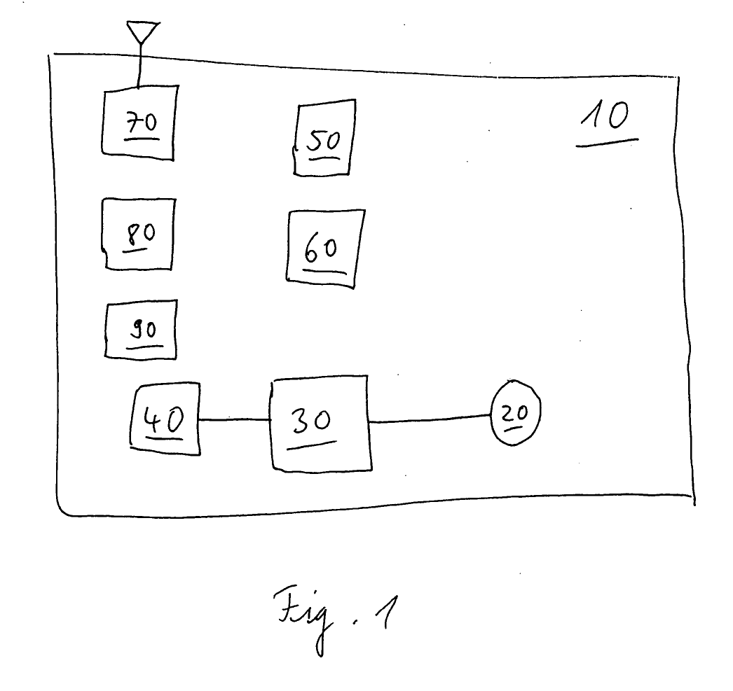

### DETAILED DESCRIPTION OF THE DRAWING

The information system 10 in a vehicle may include a storage medium 20 for storing data, a drive mechanism 30 for driving the storage medium and a control device 40 for controlling the drive mechanism.

In an exemplary embodiment of the invention, the information system 10 includes at least one sensor 80 for detecting sensor data. The at least one sensor 80 is, for example, in the form of a speed sensor, a sensor for detecting the selector lever setting and/or in the form of a sensor for detecting the setting of the handbrake or footbrake.

In another exemplary embodiment of the invention, the information system 10 is connected to the at least one sensor via a data bus such that the information system 10 can receive the sensor data via the data bus.

The information system 10 may also include, for example a navigation system having a computer 50 for calculating a route, an output unit 60 for outputting routing information, a position determination unit 70 (e.g., a GPS unit) and an input unit 90 for inputting a destination. In one embodiment of the invention, the map data for the navigation system are stored on the storage medium 20 and are read from the storage medium during operation of the navigation system.

The operating software of the information system 10 and/or the navigation system can optionally be stored on the storage medium 20. The operating software may include, for example, data relating to the control panel of the information system 10. In another embodiment of the invention, data from applications of the information system 10, such as a text-to-speech application, may be stored on the storage medium.

In an exemplary embodiment of the invention, the storage medium 20 is in the form of a hard disk. Map data for the navigation system can be stored on the hard disk and read from the hard disk during driving operations. An advantage of this embodiment is that the map data for the navigation system can easily be updated. For example, new map data can be transferred to the hard disk via an optionally provided CD drive and/or DVD drive in order to update the map data stored thereon. This requires writing operations to the hard disk. The speed of the writing operation can be altered via the control unit 40 of the drive device 30. In this case, when the vehicle is known to be at a standstill, a high writing speed is provided such that large quantities of data can be stored on the hard disk within a short period of time. This relates to, for example, an update operation of the map data on the hard disk which is carried out in a workshop. Alternatively, or in addition, the update operation at the rapid writing speed can also be carried out, for example, by the driver when the vehicle is at a standstill.

Writing of data to the hard disk is also possible if the vehicle is moving. If it is determined via the at least one sensor 80 that the vehicle is moving, a writing operation to the hard disk is possible at a lower speed than when the vehicle is at a standstill. For relatively small quantities of data, it is therefore still possible to transfer data from a CD or a DVD in an acceptable period of time. It is also possible to transfer relatively large quantities of data in this manner, but a longer time span is required for this purpose in comparison with the storage operation to the hard disk when the vehicle is at a standstill, due to the lower writing speed.

In another exemplary embodiment of the invention, measures for error correction are provided, in particular for writing operations while the vehicle is moving.

In an exemplary embodiment of the invention, prior to a certain quantity of data being transferred to the hard disk a check is carried out, to ascertain whether the state of charge of the battery allows for the transfer operation of the determined quantity of data to be brought completely to an end. The state of charge of the battery can be transmitted to the information system, for example, via a data bus. If the state of charge of the battery is not sufficiently high, the transfer operation may not even be started and/or may be moved to a later point in time. Alternatively or in addition, in the event of a threatened termination of the transfer owing to a low state of charge of the battery, it is possible to continuously check the state of charge of the battery during the data transfer to the hard disk and to maintain the original database on the hard disk. In this case, the user and/or can be informed of the fact that a data transfer operation to the hard disk of the information system has been interrupted when restarting the vehicle with a sufficiently high state of charge of the battery. It is also possible for the user and/or driver to be given the option of restarting the transfer operation and/or of continuing on from the point at which it was interrupted.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-6. (canceled)

7. An information system in a vehicle, the information system comprising:
a storage medium for storing data;
a drive device for driving the storage medium; and
a control device configured to control the drive device at two or more different speeds including a first speed and a second speed, wherein the first speed is higher than the second speed;
wherein the control device is configured:
to store data on the storage medium by driving the drive device;
to determine a standstill state of the vehicle using sensor data; and
to control the drive device at the first speed if the vehicle is at a standstill.

8. The information system as claimed in claim 7, wherein the control device is configured to determine a movement state of the vehicle using the sensor data and to control the drive device at the second speed if the vehicle is moving.

9. The information system as claimed in claim 7, wherein the information system comprises a navigation system and the data comprises map data.

10. The information system as claimed in claim 7, wherein the sensor data comprises speed data, selector lever setting data or handbrake setting data.

11. The information system as claimed in claim 7, wherein the information system is configured to receive the sensor data via a data bus.

12. The information system as claimed in claim 7, wherein the control device is configured to determine the speed of the vehicle using the sensor data and to control the drive device as a function of the speed of the vehicle at third and fourth speeds which are different from one another.

13. The information system as claimed in claim 8, wherein the information system comprises a navigation system and the data comprises map data.

14. The information system as claimed in claim 8, wherein the sensor data comprises speed data, selector lever setting data or handbrake setting data.

15. The information system as claimed in claim 9, wherein the sensor data comprises speed data, selector lever setting data or handbrake setting data.

16. The information system as claimed in claim 8, wherein the information system is configured to receive the sensor data via a data bus.

17. The information system as claimed in claim 9, wherein the information system is configured to receive the sensor data via a data bus.

18. The information system as claimed in claim 10, wherein the information system is configured to receive the sensor data via a data bus.

19. The information system as claimed in claim 8, wherein the control device is configured to determine the speed of the vehicle using the sensor data and to control the drive device as a function of the speed of the vehicle at third and fourth speeds which are different from one another.

20. The information system as claimed in claim 9, wherein the control device is configured to determine the speed of the vehicle using the sensor data and to control the drive device as a function of the speed of the vehicle at third and fourth speeds which are different from one another.

21. The information system as claimed in claim 10, wherein the control device is configured to determine the speed of the vehicle using the sensor data and to control the drive device as a function of the speed of the vehicle at third and fourth speeds which are different from one another.

22. The information system as claimed in claim 11, wherein the control device is configured to determine the speed of the vehicle using the sensor data and to control the drive device as a function of the speed of the vehicle at third and fourth speeds which are different from one another.

23. A method for managing an information system in a vehicle, comprising:
storing data in a storage medium by driving the storage medium with a drive device;
controlling the drive device with a control device at two or more different speeds including a first speed and a second speed, wherein the first speed is higher than the second speed;
determining a standstill state of the vehicle using sensor data; and
controlling the drive device at the first speed if the vehicle is at a standstill.

24. The method as claimed in claim 17, further comprising:
determining a movement state of the vehicle based on the sensor data; and
controlling the drive device at the second speed if the vehicle is moving.

25. The method as claimed in claim 17, further comprising:
receiving the sensor data via a data bus.

26. The method as claimed in claim 17, further comprising:
determining the speed of the vehicle based on the sensor data; and
controlling the drive device as a function of the speed of the vehicle at third and fourth speeds, which are different from each other.
